(19) United States
(12) Patent Application Publication
(10) Pub. No.: US 2006/0054852 A1
(43) Pub. Date: Mar. 16, 2006

(54) Diaphragm and solenoid valve equipped with diaphragm

(75) Inventors: Takahiro Kokubu, Anjo-shi (JP); Shunpei Sasago, Anjo-shi (JP); Hiroyuki Yoshida, Anjo-shi (JP); Jun Ogawa, Tokyo (JP)

Correspondence Address: OLIFF & BERRIDGE, PLC, P.O. BOX 19928, ALEXANDRIA, VA, 22320, US

(73) Assignees: Aisin AW Co., Ltd., Anjo-shi (JP); Fujikura Rubber Ltd., Tokyo (JP)

(21) Appl. No.: 11/220,778

(22) Filed: Sep. 8, 2005

(30) Foreign Application Priority Data
Sep. 14, 2004 (JP) 2004-267506
Aug. 23, 2005 (JP) 2005-241320

(51) Int. Cl. F16K 31/02

(52) U.S. Cl. 251/129.17

(57) ABSTRACT

A linear solenoid valve having a solenoid element having a plunger driven by a coil assembly and a valve element having a spool shifted by being pushed by the plunger. A diaphragm serves as an isolator for the solenoid element and includes an outer periphery portion attached to a yoke; an inner periphery portion attached to the spool; and a film portion elastically deformable in response to the shifting of the spool. The film portion is undulated and includes an outer annular protrusion disposed in an outer periphery area thereof and having a relatively large radius of curvature, and an inner annular protrusion disposed in an inner periphery area thereof and having a relatively small radius of curvature. The outer annular protrusion protrudes in a shifting direction of the spool, whereas the inner annular protrusion protrudes in a direction opposite to the direction in which the outer annular protrusion protrudes.

The disclosure of Japanese Patent Application No. 2004-267506, filed on Sep. 14, 2004, and Japanese Patent Application No. 2005-241320, filed on Aug. 23, 2005, including the specification, drawings and abstract of each application, are incorporated herein by reference in their entireties.

### BACKGROUND

The disclosure relates to diaphragms which are used in solenoid valves provided in, for example, hydraulic control devices of automotive automatic transmission units and which prevent foreign matter from entering solenoid elements of the solenoid valves. The disclosure also relates to solenoid valves equipped with such diaphragms.

A typical solenoid valve used in, for example, a hydraulic control device of an automotive automatic transmission unit is provided with a solenoid element which drives a plunger in response to a command signal from, for example, a controller (ECU); and a valve element in which a spool is shifted in response to a pushing force of the plunger in order to open and close ports. Because the ports are supplied with, for example, automatic transmission oil (ATF) which circulates throughout the automatic transmission unit, foreign matter, such as iron dust from various components, can enter the valve element.

Generally, the plunger in the solenoid element is driven by a coil in a central axial direction of the coil. The plunger is movably supported by a positioning supporter which supports and positions the moving plunger in the axial direction. The positioning supporter may be, for example, a bush or a coil assembly if the plunger is to be directly supported by the coil assembly. However, if the foreign matter entering the valve element flows into the solenoid element, the foreign matter could possibly enter a gap formed between the positioning supporter and the plunger. This may adversely affect the driving operation of the plunger. In order to solve this problem, Japanese Unexamined Patent Application Publication No. 2004-92795, which was published Mar. 25, 2004, discloses an example in which a filter is provided between the solenoid element and the valve element to prevent the intrusion of foreign matter.

In this case, however, in view of the fact that the plunger of the solenoid element must be in contact with the spool of the valve element, if a filter is to be provided between the solenoid element and the valve element as mentioned above, the plunger (or the spool) must extend through the filter. Because the filter loses its function if a through hole in the filter and the plunger form a gap therebetween, the plunger must be shifted in a sliding fashion through this through hole in the filter. Consequently, this may generate sliding friction between the plunger and the filter, and could thus cause the foreign matter to pass through the through hole.

### SUMMARY

Accordingly, it is an object to provide a diaphragm in which a reactive force generated in response to elastic deformation is reduced, and to provide a solenoid valve equipped with such a diaphragm.

Accordingly, a diaphragm is provided for a solenoid valve, the solenoid valve, including a solenoid element and a valve element, the solenoid element having a casing that houses a coil assembly including a coil and that also houses a movable unit driven by the coil, the valve element having a spool which is shifted by being pushed by the movable unit. The diaphragm includes an outer periphery portion attached to at least one of the coil assembly of the solenoid element, the casing of the solenoid element, and a main body of the valve element; an inner periphery portion attached to the spool or the movable unit; and a film portion which is disposed between the outer periphery portion and the inner periphery portion and is elastically deformed in response to the shifting of the spool. The diaphragm serves as an isolator for the solenoid element. The film portion includes an outer annular protrusion disposed annularly in an outer periphery area of the film portion and protruding in a first direction in which the movable unit pushes against the spool; and an inner annular protrusion disposed annularly in an inner periphery area of the film portion and protruding in a second direction opposite to the direction in which the outer annular protrusion protrudes. The film portion is undulated in cross section such that a radius of curvature of the inner annular protrusion is smaller than a radius of curvature of the outer annular protrusion.

Further, in a solenoid valve including a solenoid element having a casing that houses a coil assembly including a coil and that also houses a movable unit driven by the coil; a valve element having a spool which is shifted by being pushed by the movable unit; and a diaphragm serving as an isolator for the solenoid element, the diaphragm includes an outer periphery portion attached to at least one of the coil assembly of the solenoid element, the casing of the solenoid element, and a main body of the valve element; an inner periphery portion attached to the spool or the movable unit, and a film portion which is disposed between the outer periphery portion and the inner periphery portion. The film portion is elastically deformed in response to the shifting of the spool. The film portion includes an outer annular protrusion disposed annularly in an outer periphery area of the film portion and protruding in a first direction in which the movable unit pushes against the spool; and an inner annular protrusion disposed annularly in an inner periphery area of the film portion and protruding in a second direction opposite to the direction in which the outer annular protrusion protrudes. The film portion is undulated in cross section such that a radius of curvature of the inner annular protrusion is smaller than a radius of curvature of the outer annular protrusion.

Furthermore, in the solenoid valve, the spool may protrude into the solenoid element, and the inner periphery portion of the diaphragm may be attached to the spool.

Also, in the solenoid valve, the movable unit may include a plunger which is driven when the coil is electrified; and a shaft disposed between the plunger and the spool. The inner periphery portion of the diaphragm may be attached to the shaft.

Further, in the solenoid valve, the movable unit may include a plunger which is driven when the coil is electrified; and a shaft fixed to the plunger. The inner periphery portion of the diaphragm may be attached to the shaft.

Additionally, in the solenoid valve, the outer periphery portion of the diaphragm may be attached between the coil assembly and the main body of the valve element.

As described above, the film portion of the diaphragm includes the outer annular protrusion disposed in the outer periphery area of the film portion and protruding in the first direction in which the movable unit pushes against the spool; and the inner annular protrusion disposed in the inner periphery area of the film portion and protruding in the second direction opposite to the direction in which the outer annular protrusion protrudes. Moreover, the film portion is undulated in cross section such that the radius of curvature of the inner annular protrusion is smaller than the radius of curvature of the outer annular protrusion. Accordingly, when the inner periphery portion is shifted together with the spool, the magnitude of a reactive force generated in response to elastic deformation is reduced. This improves the hydraulic response of the linear solenoid valve.

Furthermore, because the diaphragm may be fixed in a manner such that the film portion is undeformed when the coil is in a non-electrified state, a load can be prevented from being applied to the film portion of the diaphragm when the coil is in a non-electrified state, that is, when the movable unit is not being driven. Accordingly, this improves the durability of the diaphragm as well as the durability of the linear solenoid valve.

Furthermore, due to the fact that the radius of curvature of the inner annular protrusion may be substantially half the radius of curvature of the outer annular protrusion, the magnitude of a reactive force generated in response to elastic deformation can be reduced.

Also, because the inner periphery portion of the diaphragm may be attached to the spool that protrudes into the solenoid element, the spool can be pushed by the movable unit, and moreover, the diaphragm can serve as an isolator for the solenoid element.

Additionally, because the inner periphery portion of the diaphragm may be attached to the shaft disposed between the plunger and the spool, the spool can be pushed by the plunger via the shaft, and moreover, the diaphragm can serve as an isolator for the solenoid element.

Further, as the inner periphery portion of the diaphragm may be attached to the shaft fixed to the plunger, the spool can be pushed by the shaft, and moreover, the diaphragm can serve as an isolator for the solenoid element.

Also, as the outer periphery portion of the diaphragm may be attached between the coil assembly and the main body of the valve element, the diaphragm can serve as an isolator for the solenoid element.

### BRIEF DESCRIPTION OF THE DRAWINGS

The description will be made with reference to the drawings in which:

FIG. 1 is a cross-sectional view of a linear solenoid valve equipped with a diaphragm;

FIGS. 2A and 2B are cross-sectional views of the diaphragm of FIG. 1, FIG. 2A illustrates the diaphragm in an undeformed state and FIG. 2B illustrates the diaphragm in a deformed state;

FIG. 3 illustrates the relationship between a film thickness and the resistance of the diaphragm;

FIG. 4 is a cross-sectional view of a linear solenoid valve according to a second embodiment;

FIG. 5 is a cross-sectional view of a linear solenoid valve according to a third embodiment;

FIG. 6 is a cross-sectional view of a linear solenoid valve equipped with a prototype diaphragm; and

FIGS. 7A and 7B are cross-sectional views of the prototype diaphragm, FIG. 7A illustrates the diaphragm in an undeformed state and FIG. 7B illustrates the diaphragm in a deformed state.

### DETAILED DESCRIPTION OF EMBODIMENTS

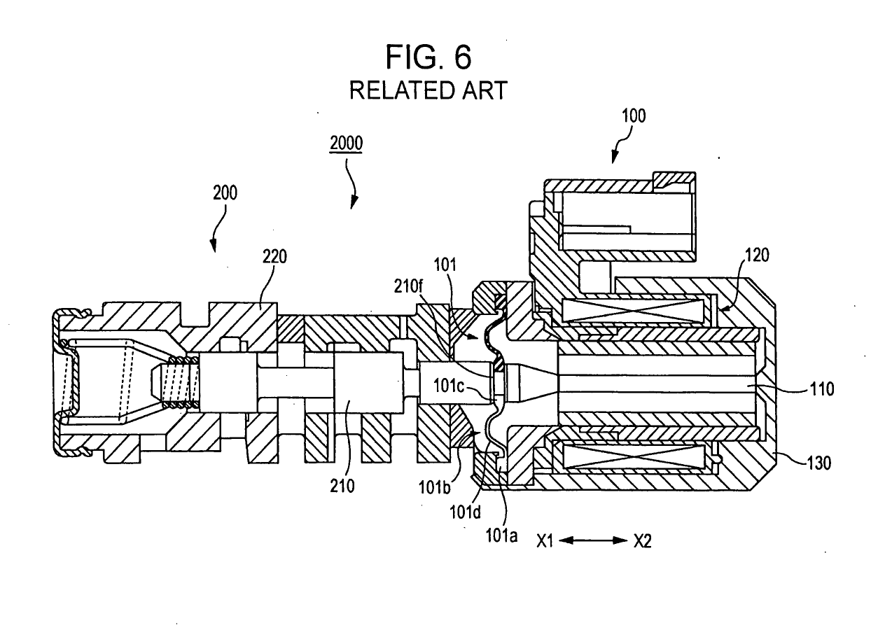

In order to address the problem of the plunger sliding in a throughhole of a filter, FIG. 6 illustrates an example of a linear solenoid valve 2000 with a prototype diaphragm 101. In the linear solenoid valve 2000, the diaphragm 101 is provided as an isolator for a solenoid element 100. The diaphragm 101 has an outer periphery portion 101a, an inner periphery portion 101c, and a convolution 101b. The diaphragm 101 is fixed in such manner that the outer periphery portion 101a is positioned properly with respect to a casing (yoke) 130 so as to seal the casing 130, and the inner periphery portion 101c is disposed in a groove 210f of a spool 210 so as to seal the groove 210f. When electricity is applied to a coil 120, a plunger 110 is driven in a direction indicated by an arrow X1. Thus, when the plunger 110 pushes the spool 210, provided in a valve element 200, in the direction of the arrow X1, the convolution 101b becomes elastically deformed. As a result, the inner periphery portion 101c moves together with the spool 210. Consequently, because there are no sliding sections, as mentioned above, in this structure, the sliding friction and the intrusion and inflow of foreign matter are prevented.

In recent years, a precise neutral control operation for controlling a power-transmission clutch just before an engagement, and a precise control operation of a clutch or a brake for alleviating gear-change shock are in great demand in, for example, an automatic transmission for automobiles. In order to achieve this, the controllability of a linear solenoid valve used for controlling the oil pressure applied to a hydraulic servo for a clutch or a brake has to be improved, meaning that an improvement in the hydraulic response of a linear solenoid valve is in great demand.

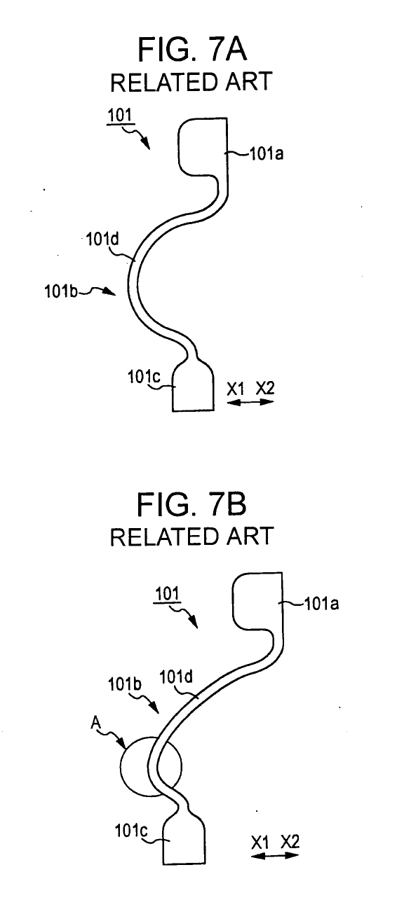

Referring to FIG. 7A, the convolution 101b of the diaphragm 101 is provided with a loose section 101d in order to prevent the convolution 101b from being tightly pulled and tensioned when the inner periphery portion 101c moves together with the spool 210. However, referring to FIG. 7B, when the convolution 101b becomes elastically deformed in response to the shifting of the inner periphery portion 101c, a stress concentration occurs particularly in section A such that a relatively large reactive force is generated in a direction indicated by an arrow X2. Such a relatively large reactive force acts as a resistance against the driving force of the plunger 110, thereby leading to a slow movement of the spool 210. This is problematic in that the hydraulic response of the linear solenoid valve 2000 is deteriorated.

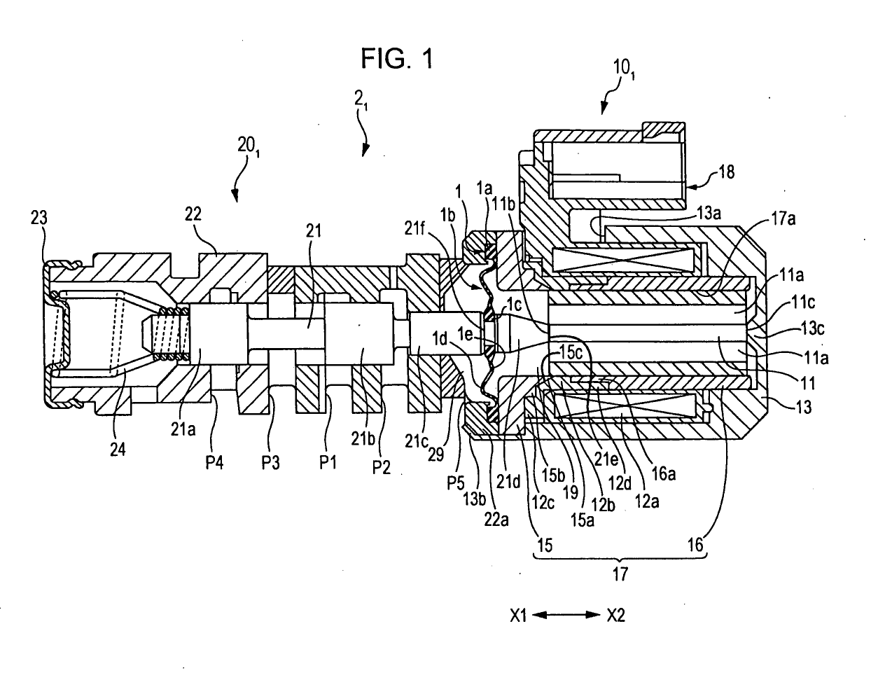

This led to exemplary embodiments now described with reference to the remaining drawings. Referring to FIG. 1, a linear solenoid valve 2₁, of the first embodiment, includes a solenoid element 10₁, and a valve element 20₁. The solenoid element 10₁ is provided with a plunger 11 defining a movable unit, a coil assembly 17, and a yoke 13 functioning as a casing. The coil assembly 17 includes a bobbin 12b composed of nonmagnetic metal, such as stainless steel (SUS); a magnet wire (not shown); end parts 15, 16 defining ferromagnetic parts composed of a ferromagnetic material, such as soft magnetic iron; a coil 12a formed of the magnet wire wound around the bobbin 12b; and a terminal 18 for transferring electric current to the coil 12a. Alternatively, the bobbin 12b may be composed of other nonmagnetic materials, such as synthetic resin, instead of metal. The end parts 15, 16 are respectively disposed at opposite ends of the bobbin 12b with respect to an axial direction thereof. The end parts 15, 16 and the bobbin 12b are integrally combined with one another by sintering, and define a core portion of the coil 12a. The soft magnetic iron used for the end parts 15, 16 preferably contains at least 95% pure iron, and more preferably contains at least 99% pure iron (at least 99% rounded off to the nearest whole number). Alternatively, instead of being integrally combined with one another by sintering, the end parts 15, 16 and the bobbin 12b may be integrally combined with one another by, for example, welding, brazing, or bonding.

Excluding the terminal 18, the coil assembly 17 has a cylindrical shape, such that the central section of the coil assembly 17 is defined by a hollow section 17a having a uniform diameter in the axial direction of the coil assembly 17. The plunger 11 slidably fits in this hollow section 17a. The plunger 11 has an outer periphery surface with a uniform diameter in the axial direction, and extends longer than the coil 12a in the axial direction.

The inner periphery side of the end part 15 of the coil assembly 17 is provided with an edge segment 15a which is tapered towards the plunger 11 and has a right-angle triangular shape in cross section. Furthermore, the end part 15 is provided with an annular step segment 15b at the base portion of the edge segment 15a. The step segment 15b serves as an engagement segment engaged with a flange segment 12c of the bobbin 12b by sintering. On the other hand, the end part 16 is provided with a cylindrical segment 16a at a side of the end part 16 adjacent to the bobbin 12b (namely, at a side in a direction indicated by an arrow X1 pointing towards the left of the drawing). The cylindrical segment 16a serves as an engagement segment engaged with an annular segment 12d of the bobbin 12b by sintering.

Specifically, when a sintering process is performed by heating the bobbin 12b and the end parts 15, 16, the bobbin 12b composed of, for example, stainless steel contracts, whereas the end parts 15, 16 composed of, for example, soft iron substantially do not contract. Consequently, this binds the particles of the end parts 15, 16 and the particles of the bobbin 12b together so that the flange segment 12c becomes pressed against and attached to the step segment 15b, and the annular segment 12d becomes pressed against and attached to the cylindrical segment 16a. Accordingly, the bobbin 12b and the end parts 15, 16 are integrally combined with one another with high bonding strength.

Although an edge segment 15a preferably has a right-angle triangular shape in cross section as described above, an inner inclined surface 15c of the edge segment 15a may alternatively be curved in cross section or be inclined in a multi-step fashion in cross section such that the steps have different inclination angles. Accordingly, the edge segment 15a may have other shapes as long as it has a tapered shape that allows magnetic saturation towards the tip thereof.

On the other hand, the plunger 11 has a first end surface 11b on which an end 21e of a spool 21, included in the valve element 201, abuts. The relationship will be described later in detail. Furthermore, the plunger 11 has a second end surface 11c at a side of the plunger 11 distant from the valve element 20. The second end surface 11c is coated with a nonmagnetic material or is surface-treated, such that the plunger 11 and the yoke 13 are magnetically disconnected from each other. The yoke 13 is provided with a projection 13c in the central portion of the inner bottom surface of the yoke 13, such that the projection 13c extends towards the plunger 11. The second end surface 11c partially abuts on the yoke 13. Consequently, this prevents the plunger 11 from being locked to the bottom surface of the yoke 13 by the magnetic force. Alternatively, instead of the second end surface 11c of the plunger 1, the bottom surface of the yoke 13 may be coated with a nonmagnetic material or be surface-treated. Accordingly, either one of the two surfaces may be coated or surface-treated as long as the magnetic poles of the yoke 13 and the plunger 11 are magnetically disconnected from each other when abutting one another.

Furthermore, the plunger 11 is provided with a plurality of through holes 11a, 11a extending between the first end surface 11b and the second end surface 11c. When the plunger 11 is driven so as to be shifted in the direction of the arrow X1, oil contained in an oil chamber 19 defined by the diaphragm 1, which will be described later in detail, passes through the through holes 11a, 11a and thus flows into a gap formed between the second end surface 11c of the plunger 11 and the yoke 13. In other words, when the plunger 11 is driven, the through holes 11a, 11a reduce the resistance caused by a change in volume.

The yoke 13 is composed of a ferromagnetic material and is formed into a cup shape by a plastic metal forming process, such as deep-drawing or cold forging. Moreover, the yoke 13 has a cutout portion 13a for the terminal 18. The material used for the yoke 13 is preferably soft magnetic iron containing at least 95% pure iron, and more preferably soft magnetic iron containing at least 99% pure iron (at least 99% rounded off to the nearest whole number). The yoke 13 engages with the coil assembly 17 so as to house the coil assembly 17. The yoke 13 has an end 13b that is caulked to a flange segment 22a of a valve body 22 of the valve element 20, so that the solenoid element 10₁ and the valve element 20, are integrally combined with each other. During the caulking process, an outer periphery portion 1a of a diaphragm 1 is disposed between the flange segment 22a of the valve body 22 and the end part 15 so that the diaphragm 1 can be positioned properly with respect to the yoke 13.

On the other hand, the valve element 20, includes the valve body 22 and the spool 21. The spool 21 is fitted in the valve body 22 in a slidable manner. Moreover, an end of the spool 21 and an end plate 23, functioning as a retainer and fixed to the valve body 22, have a spring 24 disposed therebetween in a contracted state. The spool 21 includes two large-diameter land parts 21a, 21b, and one small-diameter land part 21c. Furthermore, a side of the small-diameter land part 21c proximate the plunger 11 is provided with a pressure receiver 21d having the end 21e that abuts on the first end surface 11b of the plunger 11. Specifically, in a pre-driven state in which the pressure receiver 21d is biased by the spring 24, i.e., a state where the pressure receiver 21d is disposed at its farthest shifted position in a direction indicated by an arrow X2 in FIG. 1, the spool 21 protrudes into the hollow section 17a of the coil assembly 17 of the solenoid element 10₁, whereby the spool 21 abuts on the plunger 11. The pressure receiver 21d and the small-diameter land part 21c have a groove 21f disposed therebetween, which is where an inner periphery portion 1c of the diaphragm 1 is attached.

Furthermore, the valve body 22 is connected to, for example, a hydraulic circuit of an automatic transmission unit via a modulator valve so as to receive, for example, line pressure. The valve body 22 is provided with an input port P1 through which a predetermined oil pressure is input; an output port P3 which communicates with an output portion of, for example, a control oil chamber of the solenoid valve 2; a feedback port P2 which communicates with an oil duct extending from the output port P3; and a drainage port P4.

According to a biasing force of the spring 24 and a biasing force generated due to the difference in surface area between the land parts 21b, 21c in response to an oil pressure from the feedback port P2, the end 21e of the spool 21 constantly abuts on the first end surface 11b of the plunger 11. Thus, the spool 21 and the plunger 11 move integrally

The diaphragm 1, which is the relevant part of the disclosure, will now be described in detail. The diaphragm 1 is different from a diaphragm valve that opens and closes in response to receiving pressure, and is directed to a diaphragm that has a film structure to function as an isolator or a shield.

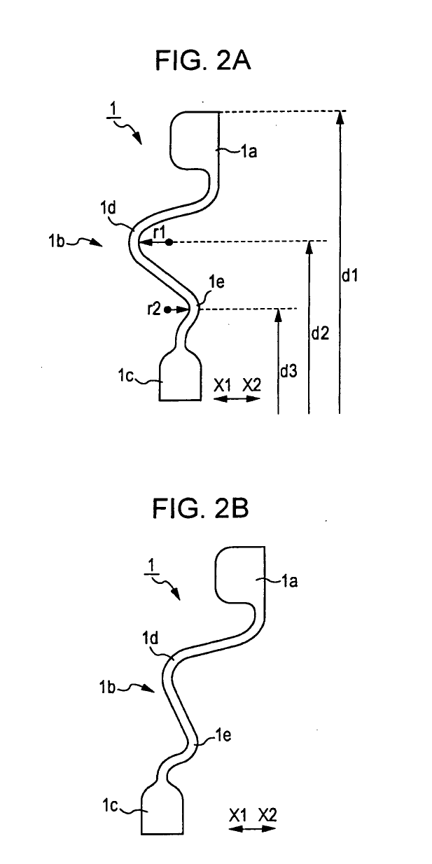

The diaphragm 1 is composed of, for example, an elastic material, such as rubber. Referring to FIGS. 1 and 2A, the diaphragm 1 includes the outer periphery portion 1a having an O-ring shape; the inner periphery portion 1c also having an O-ring shape; and a film portion 1b disposed between the outer periphery portion 1a and the inner periphery portion 1c and having a substantially grooved-disc-like structure.

An outer periphery area of the film portion 1b is provided with an outer annular protrusion 1d having a diameter d2 (for example, 10.9 mm) which is about ⅗ of an outer diameter d1 of the diaphragm 1 (for example, 18 mm). Specifically, the outer annular protrusion 1d has a radius of curvature r1 and protrudes in the direction of the arrow X1, which is the direction in which a pushing force of the plunger 11 is applied. On the other hand, an inner periphery area of the film portion 1b is provided with an inner annular protrusion 1e having a diameter d3 (for example, 7.1 mm) which is about ⅖ of the outer diameter d1 of the diaphragm 1 (for example, 18 mm). Specifically, the inner annular protrusion 1e has a radius of curvature r2 and protrudes in the direction of the arrow X2, which is the direction opposite to the direction in which the outer annular protrusion 1d protrudes. Accordingly, the diaphragm 1 has a structure in which the film portion 1b is undulated in cross section.

The radius of curvature r1 of the outer annular protrusion 1d is set to, for example, 0.8 mm, whereas the radius of curvature r2 of the inner annular protrusion 1e is set to, for example, 0.4 mm. In other words, the radius of curvature r2 of the inner annular protrusion 1e is substantially half the radius of curvature r1 of the outer annular protrusion 1d.

The outer periphery portion 1a of the diaphragm 1 is fixed by being sandwiched between the flange segment 22a of the valve body 22 and the end part 15. On the other hand, the inner periphery portion 1c is fixed by being engaged with the groove 21f of the spool 21. Consequently, when the diaphragm 1 is installed in the linear solenoid valve 2, the diaphragm 1 is tightly attached to the end part 15 so that the solenoid element 10 becomes covered and isolated by the pressure receiver 21d of the spool 21 and the film portion 1b. As a result, the oil chamber 19 surrounded by the end part 15 is formed between the diaphragm 1 and the plunger 11, and another oil chamber 29 having an output port P5 is formed between the diaphragm 1 and the valve body 22.

When the plunger 11 and the spool 21 are shifted in the direction of the arrow X2, such that the plunger 11 abuts on the bottom surface of the yoke 13, as shown in FIGS. 1 and 2A, the diaphragm 1 is in an unloaded state in which the diaphragm 1 is not elastically deformed. In other words, the diaphragm 1 is fixed in a manner such that the film portion 1b is in an undeformed state when the coil 12a is not being electrified, that is, when the plunger 11 is not being driven.

Based on the structure described above, the operation of the linear solenoid valve 2₁ will now be described. When an electric current is applied to the magnet wire from the terminal 18, the ferromagnetic components including the yoke 13, the end part 15, the plunger 11, and the end part 16 form a magnetic circuit. In this case, because the bobbin 12b is composed of a nonmagnetic material, the bobbin 12b is not a part of the magnetic circuit. Based on the magnetic circuit, the first end surface 11b of the plunger 11 and the end part 15 form a suction unit. Thus, the plunger 11 is pulled towards the end part 15 so as to be shifted in the direction of the arrow X1. In this case, due to the fact that the end part 15 included in the suction unit is provided with the tapered edge segment 15a having a right-angle triangular shape in cross section, the tapered edge segment 15a having a small cross-sectional area and defining a magnetic path becomes magnetically saturated in response to the electric current flowing through the coil 12a and the amount of stroke of the plunger 11. Accordingly, the suction characteristic with respect to the amount of stroke of the plunger 11 for each electric current value becomes relatively flat. Furthermore, because the plunger 11 constantly overlaps with the end part 15 in the axial direction, a predetermined magnetic-flux transferring section is always obtained.

Based on the amount of stroke of the plunger 11, the spool 21 moves against the biasing force of the spring 24, whereby the positioning of the spool 21 is controlled. Accordingly, the distribution ratio between the input port P1 having a cutout and the drainage port P4 is controlled, whereby the output pressure from the output port P3 is regulated in a linear fashion.

When the electric current for the coil 12a is cut off, the biasing force of the spring 24 shifts the spool 21 together with the plunger 11 in the direction of the arrow X2. Thus, a contact section 11d provided on the second end surface 11c of the plunger 11 abuts on the bottom surface of the yoke 13.

Next, the function of the diaphragm 1 will be described. As described above, when the electric current for the coil 12a is cut off, the plunger 11 and the spool 21 are shifted in the direction of the arrow X2 due to the biasing force of the spring 24, such that the plunger 11 abuts on the bottom surface of the yoke 13, as shown in FIGS. 1 and 2A. In this case, the diaphragm 1 is in an unloaded state in which the diaphragm 1 is not elastically deformed.

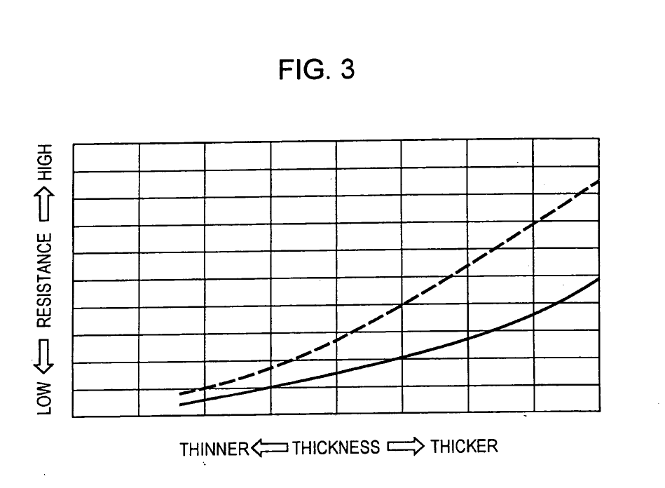

In contrast, when the electric current is applied to the coil 12a, the plunger 11 moves together with the spool 21 in the direction of the arrow X1. As a result, referring to FIG. 2B, the groove 21f of the spool 21 and the inner periphery portion 1c of the diaphragm 1 move together in the direction of the arrow X1, whereby the film portion 1b becomes elastically deformed. In this case, the outer annular protrusion 1d of the diaphragm 1 becomes stretched such that the radius of curvature r1 increases, and similarly, the inner annular protrusion 1e becomes stretched such that the radius of curvature r2 increases. For this reason, even when the inner periphery portion 1c, which is engaged with the groove 21f of the spool 21, and whose angle substantially does not change in the rotating direction of the protrusions 1d, 1e, i.e., which does not rotate with respect to the groove 21f of the spool 21, is shifted in the direction of the arrow X1, a stress concentration is prevented from occurring in the outer annular protrusion 1d and the inner annular protrusion 1e. Accordingly, referring to FIG. 3, in comparison with a comparative example of a diaphragm shown with a dashed line, the diaphragm 1, as described for the exemplary embodiment and is shown with a solid line, has lower resistance characteristics. The elastic force of the diaphragm 1 is substantially proportional to the film thickness of the film portion 1b of the diaphragm 1. For this reason, although the resistance of the diaphragm 1 increases as the film thickness becomes larger, the diaphragm 1 becomes more effective as the film thickness is increased for strength purposes relative to the comparative examples.

When the spool 21 is shifted in the direction of the arrow X1, the inner periphery portion 1c and the film portion 1b of the diaphragm 1 similarly move in the direction of the arrow X1. Although this causes the volume of an oil chamber 29 to decrease, the resistance is prevented from becoming high since the oil (or air) contained in the oil chamber 29 is discharged through the output port P5 (to the oil reservoir).

As described above, according to the diaphragm 1, the film portion 1b of the diaphragm 1 includes the outer annular protrusion 1d provided in the outer periphery area of the film portion 1b, and the inner annular protrusion 1e provided in the inner periphery area of the film portion 1b. The outer annular protrusion 1d has the relatively larger radius of curvature r1 and protrudes in the direction of the arrow X1, which is the direction in which the plunger 11 pushes against the spool 21. On the other hand, the inner annular protrusion 1e has the relatively smaller radius of curvature r2 and protrudes in the direction of the arrow X2, which is the direction opposite to the direction in which the outer annular protrusion 1d protrudes. Thus, the film portion 1b is undulated in cross section. Accordingly, when the inner periphery portion 1c is shifted together with the spool 21, the film portion 1b becomes elastically deformed in a manner such that the outer annular protrusion 1d and the inner annular protrusion 1e are substantially evenly deformed. This prevents a stress concentration from occurring in the protrusions 1d, 1e, and reduces the magnitude of a reactive force generated in response to the elastic deformation. Accordingly, the hydraulic response of the linear solenoid valve 2₁ is improved.

Furthermore, because the diaphragm 1 is fixed in a manner such that the film portion 1b is in an undeformed state when the coil 12a is not being electrified, that is, the outer periphery portion 1a may be attached to the casing 13 and the inner periphery portion 1c may be attached to the spool 21 in a manner such that the film portion 1b is undeformed when the coil 12a is in a non-electrified state, a load is prevented from being applied to the film portion 1b of the diaphragm 1 when the coil 12a is in a non-electrified state, that is, when the plunger 11 is not being driven. Accordingly, this improves the durability of the diaphragm 1 as well as the durability of the linear solenoid valve.

Furthermore, because the radius of curvature r2 of the inner annular protrusion 1e is substantially half the radius of curvature r1 of the outer annular protrusion 1d, the magnitude of a reactive force generated in response to the elastic deformation of the film portion 1b can be reduced.

Furthermore, as the linear solenoid valve 2₁ equipped with the diaphragm 1 achieves a high hydraulic response, the precision for hydraulic control of an automotive automatic transmission unit is improved. In particular, the precision for neutral control can be improved, and gear-change shock can be alleviated.

Further, because the inner periphery portion 1c of the diaphragm 1 is attached to the spool 21 that protrudes into the solenoid element 10₁, the spool 21 can be pushed by the plunger 11. Moreover, as the outer periphery portion 1a of the diaphragm 1 is attached between the coil assembly 17 and the valve body 22 of the valve element 20₁, the diaphragm 1 serves as an isolator for the solenoid element 10₁.

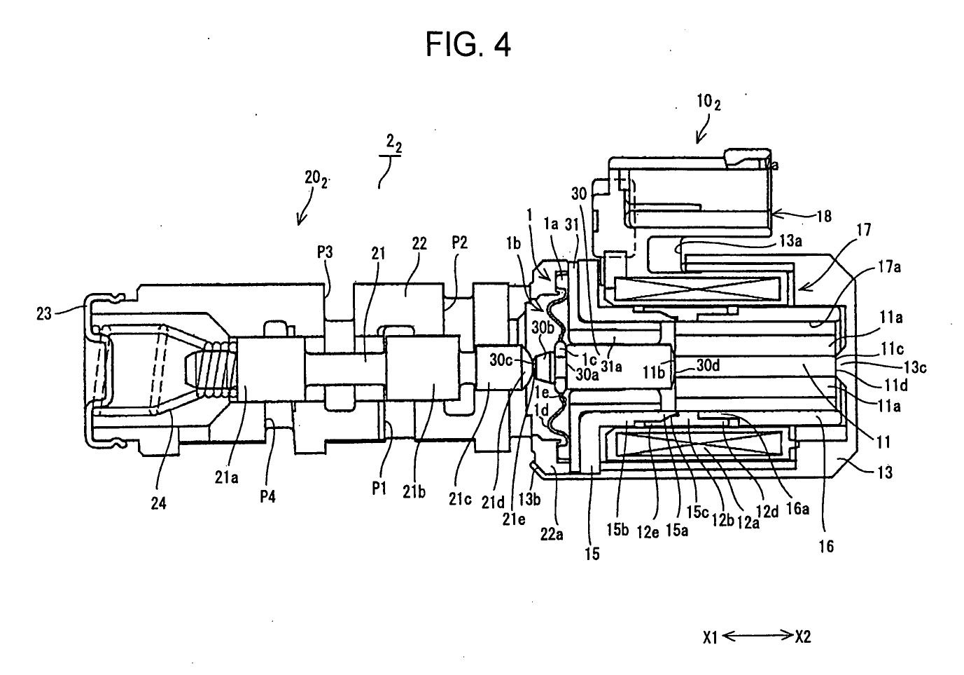

A linear solenoid valve 22 according to a second exemplary embodiment will be described with reference to FIG. 4. In this embodiment, components similar to those in the first exemplary embodiment are given the same reference numerals, and the descriptions of those components will be omitted, or minimized, below.

The linear solenoid valve 22 according to the second exemplary embodiment includes the plunger 11 and a shaft 30 serving as a movable unit in a solenoid element 10₂. The shaft 30 is disposed between the plunger 11 and the spool 21. The shaft 30 is slidably supported by a flange-like supporting member 31 (which will be referred to as a core member hereinafter) in the axial direction of the coil assembly 17, i.e., in the directions of the arrows X1, X2. The core member 31 is engaged with the hollow section 17a of the coil assembly 17.

One end portion of the shaft 30 is provided with a contact section 30b protruding into the valve element 202. A front end 30c of the contact section 30b abuts on the end 21e of the pressure receiver 21d of the spool 21. On the other hand, the other end portion of the shaft 30 is provided with an end 30d which abuts on the first end surface 11b of the plunger 11. The shaft 30 is provided with a groove 30a, which is where the inner periphery portion 1c of the diaphragm 1 is attached.

On the other hand, an inner periphery of the core member 31 is provided with, for example, V-shaped grooves 31a at two positions with respect to the circumferential direction, such that oil can flow through the V-shaped grooves 31a. During the driving operation of the plunger 11 and the shaft 30, the through holes 11a, 11a and the V-shaped grooves 31a reduce the resistance caused by a volume change in a space isolated by the diaphragm 1. Moreover, the core member 31 has a flanged end portion extending along the end part 15 and to the inner periphery of the yoke 13. Consequently, the core member 31 and the diaphragm 1 are fixed by being sandwiched between the flange segment 22a and flanged portion adjacent the end part 15.

In comparison with the plunger 11 and the spool 21 of the linear solenoid valve 2, of the first exemplary embodiment, the plunger 11 and the spool 21 of the linear solenoid valve 22, according to the second exemplary embodiment, are shorter by the dimension of the shaft 30. Consequently, because the plunger 11, especially, is shorter, the lengths of the end parts 15, 16 in the axial direction (i.e., the directions of the arrows X1, X2) and the positioning of the bobbin 12b are set in correspondence with the plunger 11. In other words, the edge segment 15a of the end part 15 is aligned with the first end surface 11b of the plunger 11.

Further, as compared to the valve element 20₁ of the linear solenoid valve 2₁, according to the first exemplary embodiment, the valve element 20₂ of the linear solenoid valve 2₂, according to the second exemplary embodiment, has the feedback port P2 and the output port P3 extending in different directions from those in the first exemplary embodiment. Alternatively, the ports P2, P3 may extend in any desired direction.

Accordingly, because the inner periphery portion 1c of the diaphragm 1 is attached to the shaft 30 disposed between the plunger 11 and the spool 21, the spool 21 can be pushed by the plunger 11 via the shaft 30. Moreover, as the outer periphery portion 1a of the diaphragm 1 is attached between the coil assembly 17 and the valve body 22 of the valve element 20₂ via the core member 31, the diaphragm 1 serves as an isolator for the solenoid element 10₂.

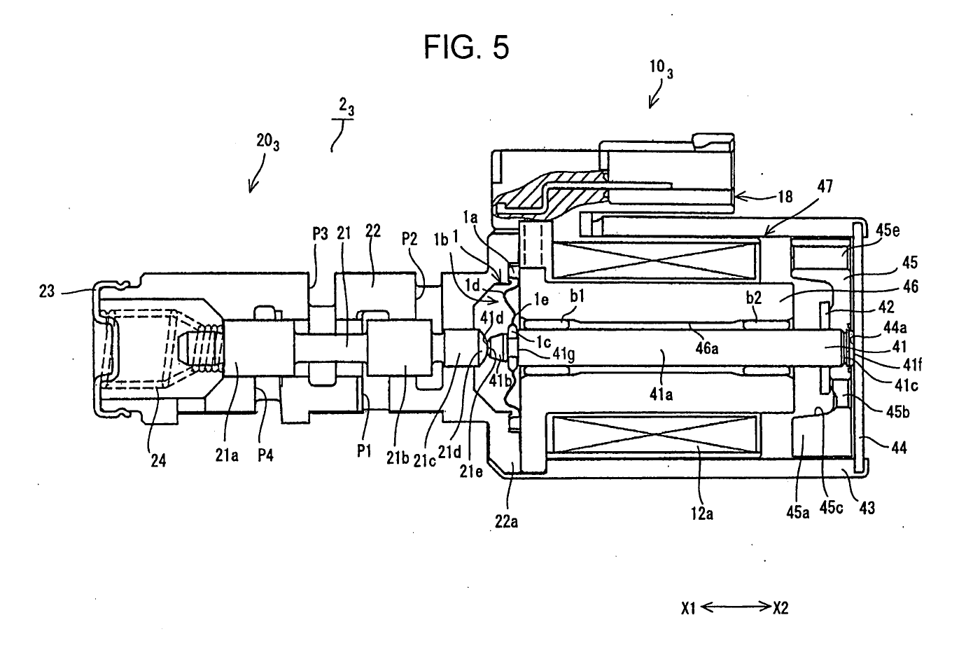

A linear solenoid valve 2₃, according to a third exemplary embodiment, will be described with reference to FIG. 5. In this embodiment, components similar to those in the above embodiments are given the same reference numerals, and the descriptions of those components will be omitted, or minimized, below.

In a solenoid element 10₃ of the linear solenoid valve 2₃ according to the third exemplary embodiment, a plunger 45 is disposed in a bottom portion (in the direction of the arrow X2 in FIG. 5) of a yoke 43. The shape of a peripheral portion 45a of the plunger 45 allows for a direct magnetic driving operation of the plunger 45. Moreover, a shaft 41 is attached to the plunger 45 such that the shaft 41 pushes the spool 21.

A coil assembly 47 includes a single-sleeve-like core member 46 composed of a ferromagnetic material, and the coil 12a wound around the core member 46. A central section of the core member 46 is defined by a hollow section 46a extending in the axial direction. The hollow section 46a holds two bushes b1, b2 between the shaft 41 and the core member 46, such that the shaft 41 is supported in a slidable manner in the axial direction via the bushes b1, b2. The bushes b1, b2 are each provided with a V-shaped groove (not shown). Similar to the second exemplary embodiment, during the driving operation of the plunger 11 and the shaft 30, the V-shaped grooves reduce the resistance caused by a volume change in a space isolated by the diaphragm 1.

On the other hand, the plunger 45 is substantially cap-shaped and has the peripheral portion 45a facing the core member 46. The peripheral portion 45a is provided with an inner inclined surface 45c that widens toward the outer periphery of the plunger 45. An attachment section 41c of the shaft 41 is caulked to the central section of the plunger 45 such that the shaft 41 is secured to the plunger 45. Furthermore, the plunger 45 is provided with a plurality of through holes 45b, 45e which allow oil to pass during a driving operation of the plunger 45 so as to prevent the driving operation of the plunger 45 from being interfered with.

The shaft 41 includes a shaft body 41a slidably supported by the bushes b1, b2. An end portion of the shaft body 41a proximate the spool 21 is provided with a contact section 41b having a first end 41d that abuts on the spool 21. On the other hand, the other end portion of the shaft body 41a proximate the bottom portion of the yoke 43 is defined by the attachment section 41c, which is caulked to the plunger 45, as described above. The attachment section 41c is provided with a second end 41f that abuts on a surface 44a of a bottom plate 44. The shaft body 41a and the contact section 41b of the shaft 41 have a groove 41g disposed therebetween, which is where the inner periphery portion 1c of the diaphragm 1 is attached.

The bottom portion of the yoke 43 is provided with the bottom plate 44 composed of, for example, stainless steel. The bottom plate 44 separates the magnetic poles of the yoke 43 and the plunger 45. Furthermore, an annular non-magnetic ring 42 composed of, for example, stainless steel, is provided around the shaft 41 and contacts an end surface of a center part of the plunger 45. Specifically, the non-magnetic ring 42 is disposed between the core member 46 and the bottom plate 44. Consequently, when an electric current is applied to the coil 12a, a magnetic circuit defined by the core member 46, the peripheral portion 45a of the plunger 45, and the yoke 43 is formed.

In comparison with the spool 21 of the linear solenoid valve 2₁ in the first exemplary embodiment, the spool 21 of the linear solenoid valve 2₃, according to the third exemplary embodiment, is shorter by the amount of the contact section 41b of the shaft 41 protruding into the valve element 20₃. On the other hand, the ports in the valve body 22 of the valve element 20₃ of the linear solenoid valve 23, according to the third exemplary embodiment, have the same structure as those in the valve element 20₂ of the linear solenoid valve 22.

Accordingly, because the inner periphery portion 1c of the diaphragm 1 is attached to the shaft 41 that is fixed to the plunger 45, the spool 21 can be pushed by the plunger 45 via the shaft 41. Moreover, as the outer periphery portion 1a of the diaphragm 1 is attached between the coil assembly 47 and the valve body 22 of the valve element 20₃, the diaphragm 1 serves as an isolator for the solenoid element 10₃.

Although each of the above exemplary embodiments is directed to a linear solenoid valve 2 in which the solenoid element 10 linearly drives the plunger 11, the diaphragm 1 is applicable to any type of solenoid valve.

Furthermore, although the diaphragm 1 is installed in the linear solenoid valve 2 in a non-elastically-deformed state in each of the above exemplary embodiments, the diaphragm 1 may alternatively be in an elastically-deformed state when the diaphragm 1 is installed in the linear solenoid valve 2. In that case, the diaphragm 1 may be switched to an unloaded (undeformed) state when the plunger 11 and the spool 21 are shifted.

Furthermore, although it is most preferable that the radius of curvature r2 of the inner annular protrusion 1e be substantially half the radius of curvature r1 of the outer annular protrusion 1d in each of the above exemplary embodiments, the diaphragm 1 may have other alternative shapes as long as the diaphragm 1 is provided with the outer annular protrusion 1d and the inner annular protrusion 1e and forms an undulated shape in cross section such that the radius of curvature of the inner annular protrusion 1e is smaller than the radius of curvature of the outer annular protrusion 1d.

What is claimed is:

1. A diaphragm, provided in a solenoid valve which includes a solenoid element and a valve element, the solenoid element having a casing that houses a coil assembly including a coil and that also houses a movable unit driven by the coil, the valve element having a spool which is shifted by being pushed by the movable unit, the diaphragm comprising:
an outer periphery portion attached to at least one of the coil assembly of the solenoid element, the casing of the solenoid element, and a main body of the valve element;
an inner periphery portion attached to one of the spool and the movable unit; and
a film portion which is disposed between the outer periphery portion and the inner periphery portion and is elastically deformed in response to the shifting of the spool, wherein the diaphragm serves as an isolator for the solenoid element, and
the film portion includes:
an outer annular protrusion disposed annularly in an outer periphery area of the film portion and protruding in a direction in which the movable unit pushes against the spool; and
an inner annular protrusion disposed annularly in an inner periphery area of the film portion and protruding in a direction opposite to the direction in which the outer annular protrusion protrudes, wherein the film portion is undulated in cross section such that a radius of curvature of the inner annular protrusion is smaller than a radius of curvature of the outer annular protrusion.

2. The diaphragm according to claim 1, wherein the outer periphery portion is attached to the casing and the inner periphery portion is attached to the spool in a manner such that the film portion is undeformed when the coil is in a non-electrified state.

3. The diaphragm according to claim 1, wherein the radius of curvature of the inner annular protrusion is substantially half the radius of curvature of the outer annular protrusion.

4. The diaphragm according to claim 2, wherein the radius of curvature of the inner annular protrusion is substantially half the radius of curvature of the outer annular protrusion.

5. A solenoid valve, comprising:
a solenoid element having a casing that houses a coil assembly including a coil and that also houses a movable unit driven by the coil;
a valve element having a spool which is shifted by being pushed by the movable unit; and
a diaphragm serving as an isolator for the solenoid element and including an outer periphery portion attached to at least one of the coil assembly of the solenoid element, the casing of the solenoid element, and a main body of the valve element; an inner periphery portion attached to one of the spool and the moveable unit; and a film portion which is disposed between the outer periphery portion and the inner periphery portion and is elastically deformed in response to the shifting of the spool, wherein the film portion includes:
an outer annular protrusion disposed annularly in an outer periphery area of the film portion and protruding in a direction in which the movable unit pushes against the spool; and
an inner annular protrusion disposed annularly in an inner periphery area of the film portion and protruding in a direction opposite to the direction in which the outer annular protrusion protrudes, wherein the film portion is undulated in cross section such that a radius of curvature of the inner annular protrusion is smaller than a radius of curvature of the outer annular protrusion.

6. The solenoid valve according to claim 5, wherein the outer periphery portion is attached to the casing and the inner periphery portion is attached to the spool in a manner such that the film portion is undeformed when the coil is in a non-electrified state.

7. The solenoid valve according to claim 5, wherein the radius of curvature of the inner annular protrusion is substantially half the radius of curvature of the outer annular protrusion.

8. The solenoid valve according to claim 6, wherein the radius of curvature of the inner annular protrusion is substantially half the radius of curvature of the outer annular protrusion.

9. The solenoid valve according to claim 5, wherein the spool protrudes into the solenoid element, and
wherein the inner periphery portion of the diaphragm is attached to the spool.

10. The solenoid valve according to claim 8, wherein the spool protrudes into the solenoid element, and
wherein the inner periphery portion of the diaphragm is attached to the spool.

11. The solenoid valve according to claim 5, wherein the movable unit includes:
a plunger which is driven when the coil is electrified; and
a shaft disposed between the plunger and the spool, wherein the inner periphery portion of the diaphragm is attached to the shaft.

12. The solenoid valve according to claim 8, wherein the movable unit includes:
a plunger which is driven when the coil is electrified; and
a shaft disposed between the plunger and the spool, wherein the inner periphery portion of the diaphragm is attached to the shaft.

13. The solenoid valve according to claim 5, wherein the movable unit includes:
a plunger which is driven when the coil is electrified; and
a shaft fixed to the plunger, wherein the inner periphery portion of the diaphragm is attached to the shaft.

14. The solenoid valve according to claim 8, wherein the movable unit includes:
a plunger which is driven when the coil is electrified; and
a shaft fixed to the plunger, wherein the inner periphery portion of the diaphragm is attached to the shaft.

15. The solenoid valve according to claim 5, wherein the outer periphery portion of the diaphragm is attached between the coil assembly and the main body of the valve element.

16. The solenoid valve according to claim 14, wherein the outer periphery portion of the diaphragm is attached between the coil assembly and the main body of the valve element.

17. A diaphragm mounted between a fixed member and a movable member, comprising:
an outer portion fixed to the fixed member;
an inner portion fixed to the movable member; and
an intermediate portion having an undulated cross-section with a first protrusion in a direction away from the fixed member and a second protrusion in an opposite direction to the first protrusion.

18. The diaphragm according to claim 17, wherein a radius of curvature of the first protrusion is substantially twice a radius curvature of the second protrusion.

19. The diaphragm according to claim 18, wherein the radius of curvature of the first protrusion is in the range of 0.6-1.0 mm.

20. The diaphragm according to claim 19, wherein the radius of curvature of the second protrusion is in the range of 0.3-0.5 mm.
